(19) United States
(12) Patent Application Publication
(10) Pub. No.: US 2025/0316011 A1
(43) Pub. Date: Oct. 9, 2025

(54) METHOD OF GENERATING VIRTUAL AVATAR BASED ON LARGE MODEL, AGENT, ELECTRONIC DEVICE AND STORAGE MEDIUM

(71) Applicant: Beijing Baidu Netcom Science Technology Co., Ltd., Beijing (CN)

(72) Inventors: Xing LIU, Beijing (CN); Jinbo WU, Beijing (CN); Xiaobo GAO, Beijing (CN); Chen ZHAO, Beijing (CN); Yan ZHANG, Beijing (CN); Haocheng FENG, Beijing (CN); Errui DING, Beijing (CN); Jingdong WANG, Beijing (CN); Tian WU, Beijing (CN); Haifeng WANG, Beijing (CN)

(21) Appl. No.: 19/241,846

(22) Filed: Jun. 18, 2025

(30) Foreign Application Priority Data
Sep. 24, 2024 (CN) 202411336634.4

(51) Int. Cl. G06T 13/40; G06T 15/04

(52) U.S. Cl. CPC G06T 13/40; G06T 15/04

(57) ABSTRACT

A method of generating a virtual avatar based on a large model, an agent, an electronic device and a storage medium, which relate to a field of artificial intelligence technology, and to fields of computer vision technology, deep learning technology, large model technology, etc., and may be applied to scenarios such as AIGC, digital character, intelligent e-commerce, etc. The method includes: processing a target image including a target object by using a large model to obtain object description information, the target object having texture information; processing the target image and a to-be-processed image representing an object morphology of a three-dimensional object by using a texture-generative large model to obtain a target three-dimensional object with target texture information, the three-dimensional object being determined based on the object description information, the target texture information being matched with the texture information; and generating the virtual avatar based on the target three-dimensional object.

### TECHNICAL FIELD

This application claims the benefit of priority to Chinese Patent Application No. 202411336634.4, filed on Sep. 24, 2024. The entire contents of this application are hereby incorporated herein by reference.

The present disclosure relates to a field of artificial intelligence technology, and in particular to fields of computer vision technology, deep learning technology, large model technology, etc., and may be applied to scenarios such as AIGC (Artificial Intelligence Generative Content), digital human, intelligent e-commerce, etc. More specifically, the present disclosure relates to a method of generating a virtual avatar based on a large model, an agent, an electronic device, and a storage medium.

### BACKGROUND

In fields of Internet e-commerce, animation games, video production, etc., an interaction with a user may be achieved by designing a virtual avatar. For example, in the field of Internet e-commerce, a commodity function may be introduced through a three-dimensional virtual avatar, so as to enhance a presentation effect of a commodity.

### SUMMARY

The present disclosure provides a method of generating a virtual avatar based on a large model, an agent, an electronic device, and a storage medium.

According to an aspect of the present disclosure, a method of generating a virtual avatar based on a large model is provided, including: processing a target image including a target object by using a large model, so as to obtain object description information, where the target object has texture information; processing the target image and a to-be-processed image representing an object morphology of a three-dimensional object by using a texture-generative large model, so as to obtain a target three-dimensional object with target texture information, where the three-dimensional object is determined based on the object description information, and the target texture information is matched with the texture information; and generating the virtual avatar based on the target three-dimensional object.

According to another aspect of the present disclosure, an artificial intelligence agent is provided, and the artificial intelligence agent is configured to perform the method provided according to embodiments of the present disclosure.

According to another aspect of the present disclosure, an electronic device is provided, including: at least one processor; and a memory communicatively connected to the at least one processor; where the memory stores instructions executable by the at least one processor, and the instructions, when executed by the at least one processor, are configured to cause the at least one processor to perform the method provided according to embodiments of the present disclosure.

According to another aspect of the present disclosure, a non-transitory computer-readable storage medium having computer instructions stored therein is provided, where the computer instructions are configured to cause a computer to perform the method provided according to embodiments of the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

Accompanying drawings are used for better understanding of the solution and do not constitute a limitation to the present disclosure, in which:

FIG. 1 schematically shows an exemplary system architecture to which a method and an apparatus of generating a virtual avatar based on a large model may be applied according to an embodiment of the present disclosure;

FIG. 2 schematically shows a flowchart of a method of generating a virtual avatar based on a large model according to an embodiment of the present disclosure;

FIG. 3 schematically shows a schematic diagram of a texture-generative large model according to an embodiment of the present disclosure;

FIG. 4 schematically shows a schematic diagram of a texture-generative large model according to another embodiment of the present disclosure;

FIG. 5 schematically shows a schematic diagram of a texture-generative large model according to another embodiment of the present disclosure;

FIG. 6 schematically shows a schematic diagram of a texture-generative large model according to yet another embodiment of the present disclosure;

FIG. 7 schematically shows an application scenario diagram of a method of generating a virtual avatar based on a large model according to an embodiment of the present disclosure;

FIG. 8 schematically shows a block diagram of an apparatus of generating a virtual avatar based on a large model according to an embodiment of the present disclosure;

FIG. 9 schematically shows a structural block diagram of an artificial intelligence agent according to an embodiment of the present disclosure; and

FIG. 10 schematically shows a block diagram of an electronic device for implementing a method of generating a virtual avatar based on a large model according to an embodiment of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those skilled in the art should achieve that various changes and modifications may be made to embodiments described herein without departing from the scope and spirit of the present disclosure. Likewise, for clarity and conciseness, descriptions of well-known functions and structures are omitted in the following description.

In the technical solution of the present disclosure, an acquisition, a storage and an application of user personal information involved comply with provisions of relevant laws and regulations, take necessary confidentiality measures and do not violate public order and good custom.

The inventors have found that, in fields of Internet e-commerce, film and television animation, etc., commodities and video plots are presented by driving a three-dimensional virtual avatar to perform a specified action task. In addition, a user may create the three-dimensional virtual avatar based on personal desires. However, it usually takes a lot of time to create a virtual avatar that is matched with user's desires, and a matching degree between a generated virtual avatar and user's actual desires is low, thereby reducing a presentation effect of the virtual avatar.

Embodiments of the present disclosure provide a method and an apparatus of generating a virtual avatar based on a large model, an agent, an electronic device, a storage medium and a program product. The method of generating a virtual avatar based on a large model includes: processing a target image including a target object by using a large model, so as to obtain object description information, where the target object has texture information; processing the target image and a to-be-processed image representing an object morphology of a three-dimensional object by using a texture-generative large model, so as to obtain a target three-dimensional object with target texture information, where the three-dimensional object is determined based on the object description information, and the target texture information is matched with the texture information; and generating the virtual avatar based on the target three-dimensional object.

According to embodiments of the present disclosure, by processing the target image using the large model, object attribute information such as an outline, a morphology, a style, etc. of the target object in the target image is learned based on a relatively powerful visual understanding ability of the large model, so that the output object description information more accurately represent an object attribute of the target object. The three-dimensional object determined based on the object description information is matched with the object attribute information represented by the object description information, therefore the to-be-processed image representing the object morphology of the three-dimensional object more accurately represents an object morphology of the target object. By processing the target image and the to-be-processed image using the texture-generative large model, the texture information of the target object in the target image and the object morphology represented by the to-be-processed image are more accurately fused, so that a generated target three-dimensional object more accurately represents, in a three-dimensional space, a matching relationship between the object morphology of the target object and the texture information of the target object. In this way, the virtual avatar generated according to the target three-dimensional object accurately represents, in the three-dimensional space, a morphology and a texture of each target object in the target image, which improves a matching degree between the virtual avatar and the target image, and further achieves an automatic and accurate generation of a three-dimensional virtual avatar that is matched with the user's desires.

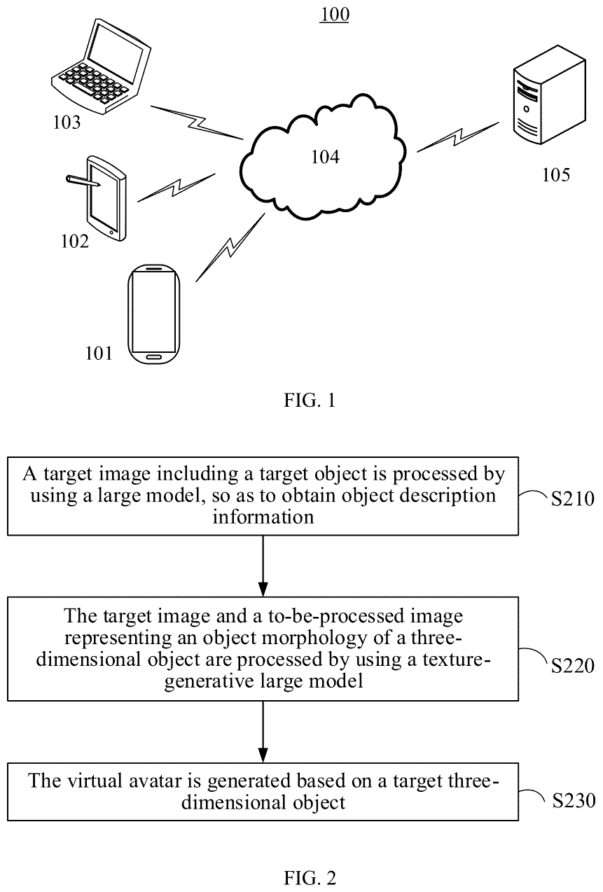

FIG. 1 schematically shows an exemplary system architecture to which a method and an apparatus of generating a virtual avatar based on a large model may be applied according to an embodiment of the present disclosure.

It should be noted that FIG. 1 shows only an example of a system architecture to which embodiments of the present disclosure may be applied, so as to help those skilled in the art understand the technical content of the present disclosure, but it does not mean that embodiments of the present disclosure may not be applied to other devices, systems, environments or scenarios. For example, in another embodiment, the exemplary system architecture to which the method and the apparatus of generating a virtual avatar based on a large model may be applied may include a terminal device. However, the terminal device may implement the method and the apparatus of generating a virtual avatar based on a large model provided in embodiments of the present disclosure without interacting with a server.

As shown in FIG. 1, a system architecture 100 according to embodiments may include terminal devices 101, 102 and 103, a network 104 and a server 105. The network 104 is used to provide a medium of a communication link between the terminal devices 101, 102 and 103 and the server 105. The network 104 may include various connection types, such as a wired and/or wireless communication link, etc.

The terminal devices 101, 102 and 103 may be used by a user to interact with the server 105 through the network 104, so as to receive or send a message, etc. Various communication client applications may be installed on the terminal devices 101, 102 and 103, such as a knowledge reading application, a web browser application, a search application, an instant messaging tool, an email client and/or a social platform software, etc. (for example only).

The terminal devices 101, 102 and 103 may be various electronic devices having a display screen and supporting web browsing, including but not limited to a smart phone, a tablet computer, a laptop computer, a desktop computer, etc.

The server 105 may be a server providing various services, such as a background management server (for example only) that provides a support for the content browsed by a user using the terminal devices 101, 102 and 103. The background management server may analyze and process received data such as a user request, etc., and feedback a processing result (such as a web page, information, or data, etc. obtained or generated according to the user request) to the terminal device.

The server may be a cloud server, also known as a cloud computing server or cloud host, which is a host product in a cloud computing service system, so as to solve defects of difficult management and weak business scalability in a traditional physical host and a VPS server (“Virtual Private Server”, or “VPS” for short). The server may also be a server of a distributed system, or a server combined with a blockchain.

It should be noted that the method of generating a virtual avatar based on a large model provided in embodiments of the present disclosure may generally be performed by the server 105. Accordingly, the apparatus of generating a virtual avatar based on a large model provided in embodiments of the present disclosure may generally be provided in the server 105. The method of generating a virtual avatar based on a large model provided in embodiments of the present disclosure may also be performed by a server or server cluster that is different from the server 105 and capable of communicating with the terminal devices 101, 102 and 103 and/or the server 105. Accordingly, the apparatus of generating a virtual avatar based on a large model provided in embodiments of the present disclosure may also be provided in a server or server cluster that is different from the server 105 and capable of communicating with the terminal devices 101, 102 and 103 and/or the server 105.

For example, any one of the terminal devices 101, 102 and 103 may acquire a target image input by the user, and then send the acquired target image to the server 105. The server 105 processes the target image by using the large model, so as to obtain object description information; processes the target image and a to-be-processed image representing an object morphology of a three-dimensional object by using a texture-generative large model, so as to obtain a target three-dimensional object with target texture information; and generates the virtual avatar based on the target three-dimensional object. Alternatively, the target image and the to-be-processed image may be processed by the server or server cluster that is capable of communicating with the terminal devices 101, 102 and 103 and/or the server 105, and then the virtual avatar may be generated.

It should be understood that the number of terminal devices, networks and servers in FIG. 1 is only schematic. According to implementation needs, any number of terminal devices, networks and servers may be provided.

FIG. 2 schematically shows a flowchart of a method of generating a virtual avatar based on a large model according to an embodiment of the present disclosure.

As shown in FIG. 2, the method of generating a virtual avatar based on a large model includes operations S210 to S230.

In the operation S210, a target image including a target object is processed by using a large model, so as to obtain object description information, and the target object has texture information.

In the operation S220, the target image and a to-be-processed image representing an object morphology of a three-dimensional object are processed by using a texture-generative large model, so as to obtain a target three-dimensional object with target texture information.

In the operation S230, the virtual avatar is generated based on the target three-dimensional object.

According to embodiments of the present disclosure, the target object in the target image may be any type of object such as a character, a clothing, an accessory, a tool, a building, a vehicle, etc. in the target image. The texture information of the target object may be represented based on pixels in an image region corresponding to the target object in the target image. For example, the texture information may be represented based on RGB (Red, Green and Blue) information of the pixels in the target image. It should be noted that the target object may represent a real object such as a character, an animal, etc., or the target object may also represent a virtual object such as an animated character, etc.

According to embodiments of the present disclosure, the large model may refer to a deep learning model with large-scale model parameters, and the large model generally contains hundreds of millions, tens of billions, hundreds of billions, trillions, or even more than ten trillion model parameters. The large model may include a multimodal large model with a visual understanding ability, such as a VideoChat model, a Video-LlaMA model, etc. The large model in embodiments of the present disclosure may be a general large model, or may be an expert large model fine-tuned based on sample object description information and sample images, which will not be limited in embodiments of the present disclosure. The large model may be used to process information of any modality such as an image, a text, a video, an audio, etc.

According to embodiments of the present disclosure, by processing the target image using the large model, object attribute information such as an outline, a morphology, a style, etc. of the target object in the target image may be learned based on a relatively powerful visual understanding ability of the large model, so that the output object description information more accurately represent an object attribute of the target object. Determining the three-dimensional object based on the object description information may include retrieving based on the object description information to obtain the three-dimensional object. A three-dimensional object morphology of the three-dimensional object may be matched with the object attribute represented by the object description information.

It should be understood that the target object may be represented based on a two-dimensional image region in the target image. The three-dimensional object may be represented based on a three-dimensional object element (e.g., a three-dimensional space point, a three-dimensional grid element) in a three-dimensional space.

According to embodiments of the present disclosure, the three-dimensional object is determined based on the object description information.

In an example, the three-dimensional object may be obtained by retrieving from a preset three-dimensional object library based on the object description information. A preset three-dimensional object in the preset three-dimensional object library may be associated with preset description information. The three-dimensional object may be determined from the preset three-dimensional object library based on a similarity between the object description information and the preset description information.

It should be understood that, under a condition of acquiring relevant authorization, a three-dimensional object matched with the object description information may also be obtained by retrieving in any database based on the object description information. For example, the three-dimensional object may be obtained by retrieving in an open-source three-dimensional model database. The specific method of determining the three-dimensional object will not be limited in embodiments of the present disclosure, as long as the three-dimensional object is matched with the object attribute information represented by the object description information.

According to embodiments of the present disclosure, the to-be-processed image may include a two-dimensional image, such as a grayscale image, a binary image, a UV map, etc. A pixel of the to-be-processed image may have a spatial positional mapping relationship with an object element of the three-dimensional object. The to-be-processed image may be obtained by performing a two-dimensional spatial mapping on object pixels of the three-dimensional object. Alternatively, the to-be-processed image may be determined based on a two-dimensional UV map for rendering the three-dimensional object.

According to embodiments of the present disclosure, the target texture information is matched with the texture information. The target texture information of the target three-dimensional object may have a spatial mapping relationship with the texture information of the target object.

According to embodiments of the present disclosure, by processing the to-be-processed image and the target image using the texture-generative large model, a semantic attribute relationship between the object morphology represented by the to-be-processed image and the texture information at a specified position of the target object in the target image may be learned based on a relatively powerful image semantic understanding ability of the texture-generative large model, so as to achieve a texture semantic attribute migration of the object morphology represented by the to-be-processed image based on the texture information of the target object. In this way, the generated target three-dimensional object more accurately represents a texture semantic attribute of the target object, and the target texture information of the target three-dimensional object is matched with the texture information of the target object, so as to improve a representation accuracy of the target three-dimensional object for representing the target object.

According to embodiments of the present disclosure, the generating the virtual avatar based on the target three-dimensional object may include fusing a plurality of target three-dimensional objects according to a positional relationship represented by the target image, so as to obtain the virtual avatar, or may also include fusing with other preset three-dimensional virtual objects based on the target three-dimensional object, so as to obtain the virtual avatar that is matched with user's desires. The specific method of generating the virtual avatar will not be limited in embodiments of the present disclosure.

According to embodiments of the present disclosure, the target object includes at least one of: a clothing object, a body part object, a vehicle object, or a building object.

According to embodiments of the present disclosure, the clothing object may represent a clothing presented in the target image, such as a suit, a long skirt, etc. worn by a character. The target three-dimensional object corresponding to the clothing object may be a three-dimensional clothing model that is matched with the texture information of the clothing object.

According to embodiments of the present disclosure, the body part object may represent any body part such as a head, a hand, an arm, etc. The target three-dimensional object corresponding to the body part object may be a three-dimensional body part model representing the body part. By fusing the three-dimensional body part models having target texture information according to a posture and a position of a character in the target image, the generated virtual avatar may more accurately represent a posture and a texture of the character in the target image, so that the virtual avatar may perform an analogue simulation on the target image more accurately, thereby improving a matching degree between the virtual avatar and the user's desires.

According to embodiments of the present disclosure, the vehicle object may represent any type of movable vehicle such as a car, a ship, an airplane, etc. The target three-dimensional object corresponding to the vehicle object may be a three-dimensional vehicle model with target texture information.

According to embodiments of the present disclosure, the building object may represent any type of building such as a house, a bridge, a warehouse, etc. The target three-dimensional object corresponding to the building object may be a three-dimensional house model, a three-dimensional bridge model, etc.

According to embodiments of the present disclosure, the texture-generative large model includes a texture-generation network. The texture-generation network may be constructed based on a generative model algorithm. For example, the texture-generation network may be constructed based on any type of generative model algorithm such as a GAN (Generative Adversaria Networks) model, a VAE (Variational auto-encoder) model, a Flow-based model, a diffusion model, etc. However, the present disclosure is not limited thereto. The texture-generation network may also be constructed based on other types of deep learning algorithms. For example, the texture generation network may be constructed based on a convolutional neural network algorithm.

According to embodiments of the present disclosure, the to-be-processed image includes a position mapping image. A position pixel of the position mapping image represents a three-dimensional coordinate of the object element in the three-dimensional object. For example, the position pixel may store a three-dimensional space coordinate (x, y, z) of an object mesh element of the three-dimensional object.

According to embodiments of the present disclosure, the position pixel represents the three-dimensional coordinate of the object element in the three-dimensional object, which may be understood as that the position pixel in the position mapping image may store the three-dimensional coordinate of the object element. The position mapping image may be determined based on the three-dimensional coordinate of the object element in the three-dimensional object.

It should be noted that a corresponding position mapping image may be constructed for the preset three-dimensional object in the preset three-dimensional object library. For example, a map pixel information of the preset UV map for rendering the preset three-dimensional object may be updated, and preset texture information stored in a map pixel of the preset UV map may be updated to a three-dimensional coordinate of an object element of the preset three-dimensional object, thereby obtaining the position mapping image.

According to embodiments of the present disclosure, the processing the target image and a to-be-processed image representing an object morphology of a three-dimensional object by using a texture-generative large model includes: performing, based on the texture generation network, a feature fusion according to an object style feature and the position mapping image, so as to obtain a target texture map matched with the texture information; and updating the three-dimensional object based on target texture information of the target texture map, so as to obtain the target three-dimensional object.

According to embodiments of the present disclosure, the object style feature is determined based on the target image. For example, a feature extraction may be performed on the target image based on an image feature extraction algorithm, so as to obtain the object style feature. The image feature extraction algorithm may include any type of deep learning algorithm such as a convolutional neural network algorithm, etc. The specific type of the image feature extraction algorithm will not be limited in embodiments of the present disclosure.

According to embodiments of the present disclosure, the object style feature represents an image semantic attribute such as a texture semantic attribute, a shape detail semantic attribute, a pattern semantic attribute, etc. of the target object. By performing, based on the texture generation network, the feature fusion on the object style feature and the position mapping image, a corresponding relationship between the three-dimensional coordinate of the object element and the object style feature may be learned using large scale model parameters of the texture generation network based on a three-dimensional coordinate stored in the position pixel as prior information, so that an image style semantics related to the target object in the target image is mapped to a three-dimensional coordinate corresponding to the object element in the three-dimensional space, and the generated target texture map may store the target texture information more accurately according to a position of the object element of the three-dimensional object in the three-dimensional space. In this way, the target texture map may more accurately determine a position of the texture information of the target object in the three-dimensional space, so that the generated target three-dimensional object may be more accurately matched with the texture information of the target object, thereby improving a representation accuracy of the target object.

It should be understood that a map pixel of the target texture map may have a spatial mapping relationship with the object element of the three-dimensional object, and the target three-dimensional object with the target texture information may be obtained by unfolding the target texture map in a three-dimensional space.

In an example, the target texture map may be processed based on a rendering engine, so as to obtain the target three-dimensional object with the target texture information.

According to embodiments of the present disclosure, the performing, based on the texture generation network, a feature fusion according to an object style feature and the position mapping image includes: performing the feature fusion on the position mapping image and a shape mask image in the to-be-processed image, so as to obtain an initial fusion feature; and performing the feature fusion based on the initial fusion feature and the object style feature, so as to obtain a target fusion feature.

According to embodiments of the present disclosure, a mask pixel of the shape mask image represents whether the object element of the three-dimensional object stores the texture information, and there is a positional mapping relationship between the mask pixel and the object element.

According to embodiments of the present disclosure, the shape mask image may be determined based on a UV map corresponding to the three-dimensional object. For example, initial texture information of a map pixel in the UV map may be updated to mask information, and the mask information may represent whether the object element stores the texture information based on a preset code, value or representation.

In an example, a pixel value of the mask pixel of the shape mask image may be represented as 1 or 0. The mask pixel of 1 indicates that an object pixel corresponding to the mask pixel needs to have target texture information, and the mask pixel of 0 indicates that the object pixel corresponding to the mask pixel does not have target texture information.

According to embodiments of the present disclosure, the performing the feature fusion on the position mapping image and a shape mask image in the to-be-processed image may include processing the position mapping image and the shape mask image based on an attention network algorithm, so as to obtain the initial fusion feature.

In an embodiment, the position mapping image and the shape mask image may be processed based on a cross attention network algorithm, so as to fully fuse a three-dimensional coordinate of an object pixel represented by the position pixel and a semantic attribute of whether the texture information needs to be stored represented by the mask pixel. In this way, by performing the feature fusion based on the initial fusion feature and the object style feature, a corresponding relationship between the pixel position of the target object and a three-dimensional spatial position of the object element of the three-dimensional object may be controlled, and a style semantic attribute of the object style feature may be accurately fused with the object element of the three-dimensional object, so as to generate the target fusion feature that more accurately represents the texture information of the target object.

According to embodiments of the present disclosure, based on the initial fusion feature obtained by fusing the mask pixel of the shape mask image and the position pixel, the texture generation network may be controlled to perform a texture semantic attribute update on the object element of the three-dimensional object to which the target texture information needs to be added, and the texture generation network may be controlled to avoid perform a texture semantic attribute update on the object element of the three-dimensional object to which the target texture information does not to be added, so that the target fusion feature may more accurately control the target texture information of the object element of the target three-dimensional object, so as to avoid a style feature migration error caused by an error in a positional mapping relationship between the object element of the three-dimensional object and a pixel of the target object, and improve a representation accuracy of the target three-dimensional object for the texture semantic attribute of the target object.

According to embodiments of the present disclosure, the target texture map may be determined based on the target fusion feature. For example, the target fusion feature may be processed based on any type of machine learning algorithm such as a fully-connected layer, so as to obtain the target texture map.

According to embodiments of the present disclosure, the texture-generative large model further includes a first style feature extraction network. The first style feature extraction network includes downsampling layers and upsampling layers having U-shaped network structures. The object style feature includes at least one level of downsampling style feature and at least one level of upsampling style feature obtained by processing the target image through the downsampling layers and the upsampling layers. The at least one level of downsampling style feature may be output by the downsampling layers, and the at least one level of upsampling style feature may be output by the upsampling layers.

According to embodiments of the present disclosure, the downsampling layer or the upsampling layer may be constructed based on a convolutional neural network algorithm. However, the present disclosure is not limited thereto. The downsampling layer or the upsampling layer may also be constructed based on other types of neural network algorithms such as an attention network algorithm, etc. The specific type of the algorithm based on which the downsampling layer or the upsampling layer is constructed will not be limited in embodiments of the present disclosure.

In an example, the downsampling layer or the upsampling layer may be constructed based on a convolutional neural network algorithm and a pooling algorithm.

According to embodiments of the present disclosure, the performing the feature fusion based on the initial fusion feature and the object style feature, so as to obtain a target fusion feature includes: performing a feature encoding operation on the initial fusion feature and the at least one level of downsampling style feature by using a texture encoder of the texture generation network, so as to obtain a first intermediate fusion feature; and performing a feature decoding operation on the first intermediate fusion feature and the at least one level of upsampling style feature by using a texture decoder of the texture generation network, so as to obtain the target fusion feature.

According to embodiments of the present disclosure, the texture generation network may include a texture encoder and a texture decoder. The texture encoder and the texture decoder may be constructed based on network structures of an encoder and a decoder in a diffusion model.

According to embodiments of the present disclosure, the feature encoding operation may be referred to as a feature encoding process performed based on the initial fusion feature and the downsampling style feature. The feature encoding operation may include performing the feature fusion on the initial fusion feature and the downsampling style feature by introducing noise information, so that the first intermediate fusion feature may fully fuse a high-level style semantic attribute in the target image according to a spatial position of a three-dimensional object represented by the initial fusion feature. The feature decoding operation may be referred to as performing the feature fusion and a feature decoding processing based on the first intermediate fusion feature and the upsampling style feature, so that the target fusion feature may fuse a style semantic attribute and restore a resolution according to a spatial position of the object element of the three-dimensional object. In this way, the target fusion feature may more accurately represent a style detail of the three-dimensional object and improve a matching degree between the target texture information of the target three-dimensional object and the texture information of the target object.

In an example, preset noise information may be introduced in the feature encoding operation and the feature decoding operation, the initial fusion feature and the object style feature may be fused through the feature encoding operation and the feature decoding operation, and feature denoising may be performed to obtain the target fusion feature.

According to embodiments of the present disclosure, the texture encoder may include a multi-level encoder layer, and the texture decoder may include a multi-level decoder layer. The encoder layer and the decoder layer may be used to perform the feature encoding operation and the feature decoding operation, respectively.

In an example, the encoder layer or the decoder layer may be constructed based on the attention network algorithm, for example, may be constructed based on a cross-attention network algorithm or a self-attention network algorithm.

In an example, the performing the feature encoding operation includes: fusing at least one level of first encoded feature with at least one level of downsampling style feature to obtain a next level of first encoded feature. A first-level first encoded feature may be determined by performing the feature encoding operation on the initial fusion feature and a first-level downsampling style feature.

In an example, the performing the feature decoding operation includes: fusing at least one level of first decoded feature with at least one level of upsampling style feature to obtain a next level of first decoded feature. A first-level first decoded feature may be determined by performing the feature decoding operation on the first intermediate fusion feature and a first-level upsampling style feature. The target fusion feature is determined based on a final-level decoded feature.

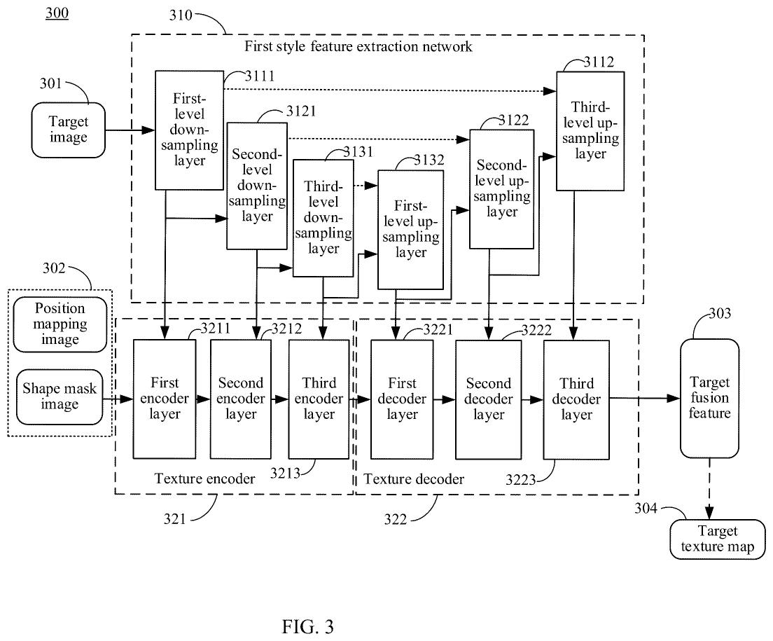

FIG. 3 schematically shows a schematic diagram of a texture-generative large model according to an embodiment of the present disclosure.

As shown in FIG. 3, a texture-generative large model 300 may include a first style feature extraction network 310 and a texture generation network, and the texture generation network includes a texture encoder 321 and a texture decoder 322. The texture generation network may be constructed based on a diffusion model algorithm. The first style feature extraction network 310 may include downsampling layers and upsampling layers determined based on U-shaped network structures. The downsampling layers and the upsampling layers may include a first-level downsampling layer 3111 and a third-level upsampling layer 3112, a second-level downsampling layer 3121 and a second-level upsampling layer 3122, a third-level downsampling layer 3131 and a first-level upsampling layer 3132. The downsampling layers or the upsampling layers may be constructed based on a convolutional neural network algorithm. A first U-shaped substructure composed of the first downsampling layer 3111 and the third upsampling layer 3112, a second U-shaped substructure composed of the second downsampling layer 3121 and the second upsampling layer 3122, and a third U-shaped substructure composed of the third downsampling layer 3131 and the first upsampling layer 3132 may be used to extract style features of different scales. The texture encoder 321 includes a first encoder layer 3211, a second encoder layer 3212 and a third encoder layer 3213 constructed based on an attention network algorithm. The texture decoder 322 includes a first decoder layer 3221, a second decoder layer 3222 and a third decoder layer 3223 constructed based on the attention network algorithm.

As shown in FIG. 3, a target image 301 is input into the first-level downsampling layer 3111 to obtain a first-level downsampling style feature. The first-level downsampling style feature is input into the second-level downsampling layer 3121 to obtain a second-level downsampling style feature. The second-level downsampling style feature is input into the third-level downsampling layer 3131 to obtain a third-level downsampling style feature. The third-level downsampling style feature and a feature map determined based on the third-level downsampling style feature are input into the first-level upsampling layer 3132 to output a first-level upsampling style feature. The first-level upsampling style feature and a feature map determined based on the second-level downsampling style feature are input into the second-level upsampling layer 3122 to output a second-level upsampling style feature. The second-level upsampling style feature and a feature map determined based on the first-level downsampling style feature are input into the third-level upsampling layer 3112 to output a third-level upsampling style feature.

An initial fusion feature 302 obtained by performing the feature fusion based on a position mapping image and a shape mask image as well as the first-level downsampling style feature are input into the first encoder layer 3211. The first encoder layer 3211 fuses the initial fusion feature 302 and the first-level downsampling style feature based on the attention network algorithm, and performs a first-level feature encoding operation based on noise information, so as to obtain a first-level first encoded feature. The first-level first encoded feature and the second-level downsampling style feature are input into the second encoder layer 3212. The second encoder layer 3212 fuses the first-level first encoded feature and the second-level downsampling style feature based on the attention network algorithm, and performs a second-level feature encoding operation based on the noise information, so as to obtain a second-level first encoded feature. The second-level first encoded feature and the third-level downsampling style feature are input into the third encoder layer 3213. The third encoder layer 3213 fuses the second-level first encoded feature and the third-level downsampling style feature based on the attention network algorithm, and performs a third-level feature encoding operation based on the noise information, so as to obtain a third-level first encoded feature. The third-level first encoded feature is determined as a first intermediate fusion feature.

As shown in FIG. 3, the third-level first encoded feature is used as the first intermediate fusion feature, and the first intermediate fusion feature and the first-level upsampling style feature are input into the first decoder layer 3221. The first decoder layer 3221 may process the first intermediate fusion feature and the first-level upsampling style feature based on the attention mechanism, so as to obtain a first-level first decoded feature by performing the feature decoding operation. The first-level first decoded feature and the second-level upsampling style feature are input into the second decoder layer 3222. The second decoder layer 3222 may process the first-level first decoded feature and the second-level upsampling style feature based on the attention mechanism, so as to obtain a second-level first decoded feature by performing the feature decoding operation. The second-level first decoded feature and the third-level upsampling style feature are input into the third decoder layer 3223. The third decoder layer 3223 may process the second-level first decoded feature and the third-level upsampling style feature based on the attention mechanism, so as to obtain a third-level first decoded feature by performing the feature decoding operation. A target fusion feature 303 may be determined based on the third-level first decoded feature. A target texture map 304 may be obtained by performing an image rendering based on the target fusion feature 303.

According to embodiments of the present disclosure, the performing a feature decoding operation on the first intermediate fusion feature and the at least one level of upsampling style feature by using a texture decoder of the texture generation network includes: performing, based on an attention mechanism, the feature decoding operation on the first intermediate fusion feature, the at least one level of upsampling style feature and the at least one level of position feature by using the texture decoder.

According to embodiments of the present disclosure, the position feature is determined based on the position mapping image. The position feature may be obtained by performing a feature extraction on the position mapping image. For example, the feature extraction may be performed on the position mapping image based on any type of algorithm such as a convolutional neural network, etc. Alternatively, the position feature may be obtained by performing a feature fusion on the initial fusion feature and the position mapping image. For example, the initial fusion feature and the position mapping image may be fused based on any type of deep learning algorithm such as a convolutional neural network algorithm, an attention network algorithm, etc., so as to obtain a single-level or multi-level position feature. The specific method of determining the position feature will not be limited in embodiments of the present disclosure.

In an example, the initial fusion feature and the position mapping image may be processed based on a plurality of convolutional neural network layers connected in cascade, so as to obtain the plurality of levels of position features. The first intermediate fusion feature, at least one level of upsampling style feature and at least one level of position feature may be processed by using the texture encoder, so as to obtain the target fusion feature.

According to embodiments of the present disclosure, the texture-generative large model may further include a position feature extraction network, and the position feature extraction network may include a plurality of levels of position feature extraction layers connected in cascade. The position feature extraction layer may be constructed based on the convolutional neural network, or the position feature extraction layer may also be constructed based on other types of neural network algorithms. A plurality of levels of position features are provided, and the plurality of levels of position features are determined by processing the target image through the plurality of levels of position feature extraction layers.

According to embodiments of the present disclosure, the plurality of levels of position feature extraction layers connected in cascade may perform the feature extraction on the position mapping image from a plurality of scales, so that the plurality of levels of position features may represent a positional mapping relationship between the three-dimensional spatial position of the object element and a two-dimensional pixel based on a position mapping semantic attribute of the position mapping image. By fusing the first intermediate fusion feature, the multi-level upsampling style feature and the plurality of levels of position features through the texture encoder in the feature decoding operation, a fine-grained and precise fusion of the positional mapping relationship and the style semantic attribute may be achieved, so as to improve a representation accuracy of the target fusion feature regarding a mapping relationship between the target texture information and a coordinate of the object element, thereby improving a matching degree between the target three-dimensional object and the target object in the target image.

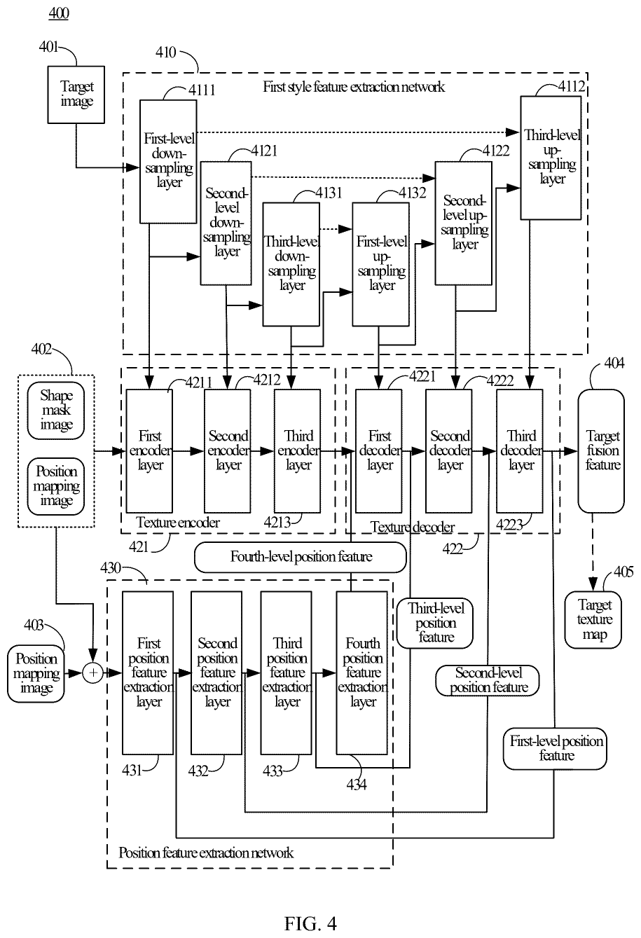

FIG. 4 schematically shows a schematic diagram of a texture-generative large model according to another embodiment of the present disclosure.

As shown in FIG. 4, a texture-generative large model 400 may include a first style feature extraction network 410, a texture generation network and a position feature extraction network 430, and the texture generation network includes a texture encoder 421 and a texture decoder 422. The texture generation network may be constructed based on a diffusion model algorithm. The first style feature extraction network 410 may include downsampling layers and upsampling layers determined based on U-shaped network structures. The downsampling layers and the upsampling layers may include a first-level downsampling layer 4111 and a third-level upsampling layer 4112, a second-level downsampling layer 4121 and a second-level upsampling layer 4122, a third-level downsampling layer 4131 and a first-level upsampling layer 4132. The downsampling layers or the upsampling layers may be constructed based on the convolutional neural network algorithm. The first downsampling layer 4111 and the third upsampling layer 4112 form a U-shaped substructure, the second downsampling layer 4121 and the second upsampling layer 4122 form another U-shaped substructure, and the third downsampling layer 4131 and the first upsampling layer 4132 form a third U-shaped substructure. The three nested U-shaped substructures may be used to extract style features of different scales. The texture encoder 421 includes a first encoder layer 4211, a second encoder layer 4212, and a third encoder layer 4213 constructed based on an attention network algorithm. The texture decoder 422 includes a first decoder layer 4221, a second decoder layer 4222, and a third decoder layer 4223 constructed based on the attention network algorithm. The position feature extraction network 430 includes a first position feature extraction layer 431, a second position feature extraction layer 432, a third position feature extraction layer 433, and a fourth position feature extraction layer 434 connected in cascade. The first position feature extraction layer 431, the second position feature extraction layer 432, the third position feature extraction layer 433 and the fourth position feature extraction layer 434 are constructed based on convolutional neural network algorithms of different scales.

As shown in FIG. 4, a target image 401 is input into the first-level downsampling layer 4111 to obtain a first-level downsampling style feature. The first-level downsampling style feature is input into the second-level downsampling layer 4121 to obtain a second-level downsampling style feature. The second-level downsampling style feature are input into the third-level downsampling layer 4131 to obtain a third-level downsampling style feature. The third-level downsampling style feature and a feature map determined based on the third-level downsampling style feature are input into the first-level upsampling layer 4132 to output a first-level upsampling style feature. The first-level upsampling style feature and a feature map determined based on the second-level downsampling style feature are input into the second-level upsampling layer 4122 to output a second-level upsampling style feature. The second-level upsampling style feature and a feature map determined based on the first-level downsampling style feature are input into the third-level upsampling layer 4112 to output a third-level upsampling style feature.

As shown in FIG. 4, a position mapping image 403 and an initial fusion feature 402 are added and then input into the first position feature extraction layer 431 to obtain a first-level position feature. The first-level position feature is input into the second-level position feature extraction layer 432 to obtain a second-level position feature. The second-level position feature is input into the third position feature extraction layer 433 to obtain a third-level position feature. The third-level position feature is input into the fourth position feature extraction layer 434 to obtain a fourth-level position feature.

As shown in FIG. 4, the initial fusion feature 402 obtained by performing the feature fusion based on a position mapping image and a shape mask image as well as the first-level downsampling style feature are input into the first encoder layer 4211. The first encoder layer 4211 fuses the initial fusion feature 402 and the first-level downsampling style feature based on the attention network algorithm, and performs a first-level feature encoding operation based on noise information, so as to obtain a first-level first encoded feature. The first-level first encoded feature and the second-level downsampling style feature are input into the second encoder layer 4212. The second encoder layer 4212 fuses the first-level first encoded feature and the second-level downsampling style feature based on the attention network algorithm, and performs a second-level feature encoding operation based on the noise information, so as to obtain a second-level first encoded feature. The second-level first encoded feature and the third-level downsampling style feature are input into the third encoder layer 4213. The third encoder layer 4213 fuses the second-level first encoded feature and the third-level downsampling style feature based on the attention network algorithm, and performs a third-level feature encoding operation based on the noise information, so as to obtain a third-level first encoded feature. The third-level first encoded feature is determined as a first intermediate fusion feature.

As shown in FIG. 4, the third-level first encoded feature is used as the first intermediate fusion feature, and the first intermediate fusion feature, the first-level upsampling style feature, and the fourth-level position feature are input into the first decoder layer 4221. The first decoder layer 4221 may process the first intermediate fusion feature, the first-level upsampling style feature, and the fourth-level position feature based on the attention mechanism, so as to obtain a first-level first decoded feature by performing the feature decoding operation. The first-level first decoded feature, the second-level upsampling style feature, and the third-level position feature are input into the second decoder layer 4222. The second decoder layer 4222 may process the first-level first decoded feature, the second-level upsampling style feature, and the third-level position feature based on the attention mechanism, so as to obtain a second-level first decoded feature by performing the a feature decoding operation. The second-level first decoded feature, the second-level position feature, and the third-level upsampling style feature are input into the third decoder layer 4223. The third decoder layer 4223 may process the second-level first decoded feature, the second-level position feature, and the third-level upsampling style feature based on the attention mechanism, so as to obtain a third-level first decoded feature by performing the feature decoding operation. A target fusion feature 404 may be determined by performing the feature fusion based on the third-level first decoded feature and the first-level position feature. A target texture map 405 may be obtained by performing an image rendering based on the target fusion feature 404.

According to embodiments of the present disclosure, the texture-generative large model further includes a second style feature extraction network including multi-level style feature extraction layers connected in cascade. The style feature extraction layer may be constructed based on any type of neural network algorithm such as a convolutional neural network algorithm, an attention network algorithm, etc.

According to embodiments of the present disclosure, the object style feature includes a plurality of levels of style features obtained by processing the object style feature through a plurality of levels of style extraction layers. The plurality of levels of style features may represent style semantic attributes of the target image at different scale attributes.

According to embodiments of the present disclosure, performing the feature fusion based on the initial fusion feature and the object style feature to obtain the target fusion feature includes: performing a feature encoding operation on the initial fusion feature by using a texture encoder of the texture generation network, so as to obtain a second intermediate fusion feature; and performing a feature decoding operation on the second intermediate fusion feature and at least one level of style feature by using a texture decoder of the texture generation network, so as to obtain the target fusion feature.

According to embodiments of the present disclosure, the texture encoder may include multi-level encoder layers connected in cascade, and the encoder layer may be constructed based on the attention network algorithm. A first-level encoder layer may process the initial fusion feature and the noise information based on the attention network algorithm, so as to obtain a first-level encoded feature by performing the feature encoding operation on the initial fusion feature. A second-level encoder layer may process the first-level encoded feature and the noise information based on the attention network, so as to obtain a second-level encoded feature by performing the feature encoding operation on the first-level encoded feature. A second-level intermediate fusion feature may be determined based on a last-level encoded feature output by a last-level encoder layer. For example, the second intermediate fusion feature may be obtained by performing an autonomous fusion on the last-level encoded feature.

According to embodiments of the present disclosure, the feature decoding operation may be performed on the second intermediate fusion feature and the at least one level of style feature based on a multi-level decoder layer of the texture decoder. For example, based on the attention network algorithm, the second intermediate fusion feature and the at least one level of style feature may be processed by using a first-level decoder layer, so as to obtain a first-level decoded feature by performing the feature decoding operation on the second intermediate fusion feature. Based on the attention network algorithm, the first-level decoded feature and the at least one level of style feature may be processed by using a second-level decoder layer, so as to obtain a second-level decoded feature by performing the feature decoding operation on the first-level decoded feature. The target fusion feature may be determined based on a last-level decoded feature obtained by performing the feature decoding operation on a last-level decoder layer.

According to embodiments of the present disclosure, by fusing the second intermediate fusion feature and the at least one level of style feature in a process of performing the feature decoding operation by using the texture decoder, a correlation between a position semantic attribute and a style semantic attribute of the object element may be enhanced in a stage of restoring a semantic attribute of a target map, so as to improve an accuracy of a correlation between the style semantic attribute and a three-dimensional spatial coordinate of the object element in the target fusion feature, and a data processing load for generating the target fusion feature by the texture-generative large model may also be reduced, so as to save a computational overhead and improve a representation accuracy of the target fusion feature for representing the target texture information of the three-dimensional object.

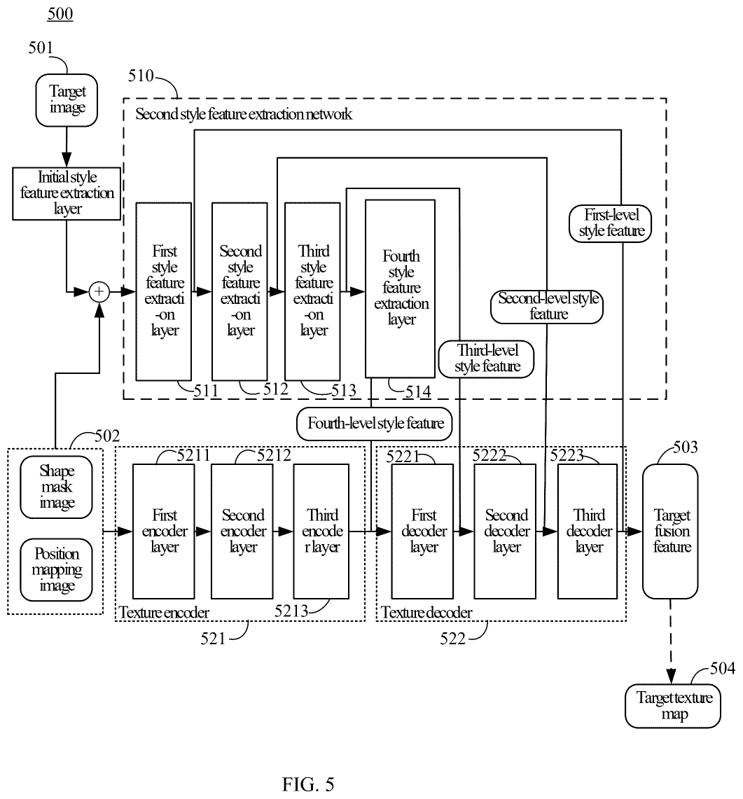

FIG. 5 schematically shows a schematic diagram of a texture-generative large model according to yet another embodiment of the present disclosure.

As shown in FIG. 5, a texture-generative large model 500 may include a second style feature extraction network 510 and a texture generation network, and the texture generation network includes a texture encoder 521 and a texture decoder 522. The texture generation network may be constructed based on a diffusion model algorithm. The second style feature extraction network 510 may include a plurality of style feature extraction layers determined based on a cascaded network structure. The plurality of style feature extraction layers may include a first style feature extraction layer 511, a second style feature extraction layer 512, a third style feature extraction layer 513, and a fourth style feature extraction layer 514. The style feature extraction layer may be constructed based on a convolutional neural network algorithm, and the plurality of style feature extraction layers may be used to extract style feature maps of different scales in the target image. The texture encoder 521 includes a first encoder layer 5211, a second encoder layer 5212, and a third encoder layer 5213 constructed based on an attention network algorithm. The texture decoder 522 includes a first decoder layer 5221, a second decoder layer 5222, and a third decoder layer 5223 constructed based on the attention network algorithm.

As shown in FIG. 5, a target image 501 is processed by an initial style feature extraction layer, so as to obtain an initial style feature. The initial style feature is added to an initial fusion feature 502 obtained by performing a feature fusion based on a position mapping image and a shape mask image to achieve the feature fusion, so as to obtain a target initial style feature. The target initial style feature is input into the first style feature extraction layer 511 to extract a style semantic feature of a first scale, so as to obtain a first-level style feature. The first-level style feature is input into the second style feature extraction layer 512 to extract a style semantic feature of a second scale, so as to obtain a second-level style feature. The second-level style feature is input into the third style feature extraction layer 513 to extract a style semantic feature of a third scale, so as to obtain a third-level style feature. The third-level style feature is input into the fourth style feature extraction layer 514 to extract a style semantic feature of a fourth scale, so as to obtain a fourth-level style feature.

In a feature encoding stage, the performing a feature encoding operation on the initial fusion feature by using a texture encoder of the texture generation network, so as to obtain a second intermediate fusion feature may include the following operations. By using the first encoder layer 5211 as a first-level encoder layer, the initial fusion feature 502 and the noise information may be processed based on the attention network algorithm, so as to obtain a first-level encoded feature by performing the feature encoding operation on the initial fusion feature. By using the second encoder layer 5212 as a second-level encoder layer, the first-level encoded feature and the noise information may be processed based on the attention network algorithm, so as to obtain a second-level encoded feature by performing the feature encoding operation on the first-level encoded feature. By using the third encoder layer 5213 as a third-level encoder layer, the second-level encoded feature and the noise information may be processed based on the attention network algorithm, so as to obtain a third-level encoded feature by performing the feature encoding operation on the second-level encoded feature. The third-level encoded feature may be used as a second-level intermediate fusion feature.

In a feature decoding stage, the first decoder layer 5221 of the texture decoder 522 performs a first-level feature decoding operation by fusing the second intermediate fusion feature and the fourth-level style feature based on an attention mechanism, so as to obtain a first-level decoded feature. The second decoder layer 5222 performs a second-level feature decoding operation by fusing the first-level decoded feature and the third-level style feature based on the attention mechanism, so as to obtain a second-level decoded feature. The third decoder layer 5223 performs a third-level feature decoding operation by fusing the second-level decoded feature and the second-level style feature based on the attention mechanism, so as to obtain a third-level decoded feature. A target fusion feature 503 may be obtained by performing the feature fusion on the third-level decoded feature and the first-level style feature. A target texture map 504 may be obtained by performing an image rendering based on the target fusion feature 503.

According to embodiments of the present disclosure, the performing a feature decoding operation on the second intermediate fusion feature and at least one level of style feature by using a texture decoder of the texture generation network includes: performing, based on an attention mechanism, the feature decoding operation on the second intermediate fusion feature, the at least one level of style feature and at least one level of position feature by using the texture decoder.

According to embodiments of the present disclosure, the feature decoding operation may be performed on the second intermediate fusion feature, the at least one level of style feature and the at least one level of position feature based on a multi-level decoder layer of the texture decoder. For example, based on the attention network algorithm, the second intermediate fusion feature, the at least one level of style feature and the at least one level of position feature may be processed by using a first-level decoder layer, so as to obtain the first-level decoded feature by performing the feature decoding operation on the second intermediate fusion feature. Based on the attention network algorithm, the first-level decoded feature, the at least one level of style feature and the at least one level of position feature may be processed by using a second-level decoder layer, so as to obtain the second-level decoded feature by performing the feature decoding operation on the first-level decoded feature. The target fusion feature may be determined based on a last-level decoded feature obtained by performing the feature decoding operation on a last-level decoder layer.

According to embodiments of the present disclosure, by fusing the second intermediate fusion feature, the at least one level of style feature and the at least one level of position feature in a process of performing the feature decoding operation by using the texture decoder, a correlation between a position semantic attribute and a style semantic attribute of the object element may be enhanced based on a coordinate of the object element represented by the position feature in a three-dimensional space in a stage of restoring a semantic attribute of a target map, so as to improve an accuracy of a correlation between the style semantic attribute and a three-dimensional space coordinate of the object element in the target fusion feature, and a data processing load for generating the target fusion feature by the texture-generative large model may also be reduced, so as to save a computational overhead and improve a representation accuracy of the target fusion feature for representing the target texture information of the three-dimensional object.

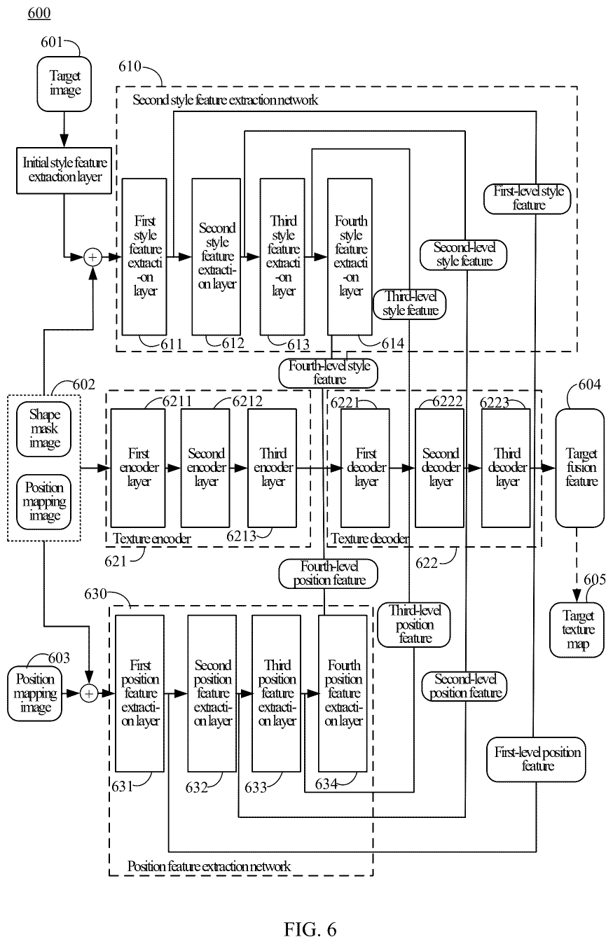

FIG. 6 schematically shows a schematic diagram of a texture-generative large model according to yet another embodiment of the present disclosure.

As shown in FIG. 6, a texture-generative large model 600 may include a second style feature extraction network 610, a texture generation network, and a position feature extraction network 630. The texture generation network includes a texture encoder 621 and a texture decoder 622. The texture generation network may be constructed based on a diffusion model algorithm. The second style feature extraction network 610 may include a plurality of style feature extraction layers determined based on a cascaded network structure. The plurality of style feature extraction layers may include a first style feature extraction layer 611, a second style feature extraction layer 612, a third style feature extraction layer 613, and a fourth style feature extraction layer 614. The style feature extraction layer may be constructed based on a convolutional neural network algorithm, and the plurality of style feature extraction layers may be used to extract style feature maps of different scales in the target image. The texture encoder 621 includes a first encoder layer 6211, a second encoder layer 6212, and a third encoder layer 6213 constructed based on an attention network algorithm. The texture decoder 622 includes a first decoder layer 6221, a second decoder layer 6222, and a third decoder layer 6223 constructed based on the attention network algorithm. The position feature extraction network 630 includes a first position feature extraction layer 631, a second position feature extraction layer 632, a third position feature extraction layer 633, and a fourth position feature extraction layer 634 connected in cascade. The first position feature extraction layer 631, the second position feature extraction layer 632, the third position feature extraction layer 633, and the fourth position feature extraction layer 634 are constructed based on convolutional neural network algorithms of different scales.

As shown in FIG. 6, a target image 601 may be processed by an initial style feature extraction layer, so as to obtain an initial style feature. The initial style feature is added to an initial fusion feature 602 obtained by performing a feature fusion based on a position mapping image and a shape mask image to achieve the feature fusion, so as to obtain a target initial style feature. The target initial style feature is input into the first style feature extraction layer 611 to extract a style semantic feature of a first scale, so as to obtain a first-level style feature. The first-level style feature is input into the second style feature extraction layer 612 to extract a style semantic feature of a second scale, so as to obtain a second-level style feature. The second-level style feature is input into the third style feature extraction layer 613 to extract a style semantic feature of a third scale, so as to obtain a third-level style feature. The third-level style feature is input into the fourth style feature extraction layer 614 to extract a style semantic feature of a fourth scale, so as to obtain a fourth-level style feature.

As shown in FIG. 6, a position mapping image 603 is added to the initial fusion feature 602 to achieve the feature fusion, and a fused initial position fusion feature is input into the first position feature extraction layer 631 to obtain a first-level position feature. The first-level position feature is input into the second position feature extraction layer 632 to obtain a second-level position feature. The second-level position feature is input into the third-level position feature extraction layer 633 to obtain a third-level position feature. The third-level position feature is input into the fourth-level position feature extraction layer 634 to obtain a fourth-level position feature.

In a feature encoding stage, the performing a feature encoding operation on the initial fusion feature by using a texture encoder of the texture generation network, so as to obtain a second intermediate fusion feature may include the following operations. By using the first encoder layer 6211 as a first-level encoder layer, the initial fusion feature 602 and the noise information may be processed based on the attention network algorithm, so as to obtain a first-level encoded feature by performing the feature encoding operation on the initial fusion feature. By using the second encoder layer 6212 as a second-level encoder layer, the first-level encoded feature and the noise information may be processed based on the attention network algorithm, so as to obtain a second-level encoded feature by performing the feature encoding operation on the first-level encoded feature. By using the third encoder layer 6213 as a third-level encoder layer, the second-level encoded feature and the noise information may be processed based on the attention network algorithm, so as to obtain a third-level encoded feature by performing the feature encoding operation on the second-level encoded feature. The third-level encoded feature may be used as a second-level intermediate fusion feature.

In a feature decoding stage, the first decoder layer 6221 of the texture decoder 622 performs a first-level feature decoding operation by fusing the second intermediate fusion feature, the fourth-level position feature and the fourth-level style feature based on the attention mechanism, so as to obtain a first-level decoded feature. The second decoder layer 6222 performs a second-level feature decoding operation by fusing the first-level decoded feature, the third-level position feature and the third-level style feature based on the attention mechanism, so as to obtain a second-level decoded feature. The third decoder layer 6223 performs a third-level feature decoding operation by fusing the second-level decoded feature, the second-level position feature and the second-level style feature based on the attention mechanism, so as to obtain a third-level decoded feature. A target fusion feature 604 may be obtained by performing the feature fusion on the third-level decoded feature, the first-level position feature and the first-level style feature. A target texture map 605 may be obtained by performing an image rendering based on the target fusion feature 604.

According to embodiments of the present disclosure, the processing the target image and a to-be-processed image representing an object morphology of a three-dimensional object by using a texture-generative large model may include: processing the target image and an object depth map of the to-be-processed image based on the texture-generative large model, so as to obtain a target texture image; and performing a texture attribute update on the three-dimensional object based on the target texture image, so as to obtain the target three-dimensional object.

According to embodiments of the present disclosure, the object depth map represents an image of the three-dimensional object at a specified viewing angle. The specified viewing angle may represent a front viewing angle, a back viewing angle, a top viewing angle, etc. of the three-dimensional object. However, the present disclosure is not limited thereto. The specified viewing angle may also include any other viewing angle for observing the three-dimensional object, such as a viewing angle for observing the three-dimensional object at a 45-degree angle from diagonally above. The specific type of the specified viewing angle will not be limited in embodiments of the present disclosure.

According to embodiments of the present disclosure, a depth map pixel of the object depth map may represent depth information of an object element of the three-dimensional object at the specified viewing angle, and a pixel coordinate of the depth map pixel may correspond to coordinate information of a projection plane corresponding to the object element at the specified viewing angle. A coordinate of the object element in the three-dimensional space may be represented based on a pixel coordinate and depth information of an object depth map pixel. For example, a coordinate system conversion may be performed on a pixel coordinate and depth information of the object depth map based on a camera parameter corresponding to the specified viewing angle, so as to obtain a coordinate of the object element that may be observed at the specified viewing angle.

According to embodiments of the present disclosure, the performing a texture attribute update on the three-dimensional object based on the target texture image, so as to obtain the target three-dimensional object may include updating texture information of the three-dimensional object by using pixel texture information of the target texture image based on a positional mapping relationship between an image pixel of the target texture image and the object element of the three-dimensional object, so as to obtain the target three-dimensional object with the target texture information.

According to embodiments of the present disclosure, the texture-generative large model may learn a mapping relationship between the object depth map of the specified viewing angle and the object element by fine-tuning a model. Therefore, by processing the target image and the object depth map of the to-be-processed image based on the texture-generative large model, the texture-generative large model may be controlled based on the depth map pixel and depth information of the object depth map to perform a texture semantic attribute fusion on texture information of the target object in the target image according to the coordinate of the object element represented in the three-dimensional space, thereby accurately performing a texture semantic attribute update on the object element of the three-dimensional object at the specified viewing angle. Therefore, the target texture image obtained may more accurately represent a result of presenting the three-dimensional object according to a texture semantic attribute of the target object at the specified viewing angle. In this way, the target three-dimensional object generated based on the target texture image may more accurately represent the texture semantic attribute of the target object in the three-dimensional space, and improve a matching degree between the target three-dimensional object and the target object in the target image.

According to embodiments of the present disclosure, the performing a texture attribute update on the three-dimensional object based on the target texture image, so as to obtain the target three-dimensional object includes: determining a pixel mapping relationship between a first pixel of the target texture image and a second pixel of an initial object map based on the target texture image and the object depth map, where the initial object map is determined based on the three-dimensional object; updating, based on the pixel mapping relationship, the initial object map according to target texture information of the target texture image, so as to obtain a target object map; and performing an object rendering based on the target object map, so as to obtain the target three-dimensional object.

According to embodiments of the present disclosure, the initial object map is determined based on the three-dimensional object. The initial object map may be, for example, a UV map for rendering the three-dimensional object. A pixel coordinate of the second pixel of the initial object map may have a positional mapping relationship with a three-dimensional coordinate of the object element in the three-dimensional space.

According to embodiments of the present disclosure, the first pixel and the second pixel having the pixel mapping relationship therebetween may represent an object element at the same position in the three-dimensional space. A coordinate system alignment may be performed on the first pixel of the target texture image and the depth map pixel of the object depth map based on a preset camera parameter, thereby obtaining an aligned target texture image and an aligned object depth map. Based on an aligned first pixel and an aligned depth map pixel, the aligned first pixel may determine a second pixel representing the object element at the same position from the initial object map based on the depth information of the associated depth map pixel, thereby determining the pixel mapping relationship between the first pixel and the second pixel.

According to embodiments of the present disclosure, the updating, based on the pixel mapping relationship, the initial object map according to target texture information of the target texture image includes: updating, based on the pixel mapping relationship, the initial object map by using the target texture information of the target texture image at a plurality of specified viewing angles.

According to embodiments of the present disclosure, the target texture image at the plurality of specified viewing angles may represent target texture information of the object element of the three-dimensional object observed at the plurality of specified viewing angles. The second pixel having the pixel mapping relationship may be updated by the target texture information of the first pixel at the plurality of specified viewing angles, so that a map pixel of the obtained target object map may represent the target texture information of the object element at the plurality of specified viewing angles. Therefore, the target three-dimensional object is rendered based on the target object map, so that the target texture information of the target three-dimensional object may more accurately match the texture information of the target object, so as to improve a matching degree between the target three-dimensional object and the target object.

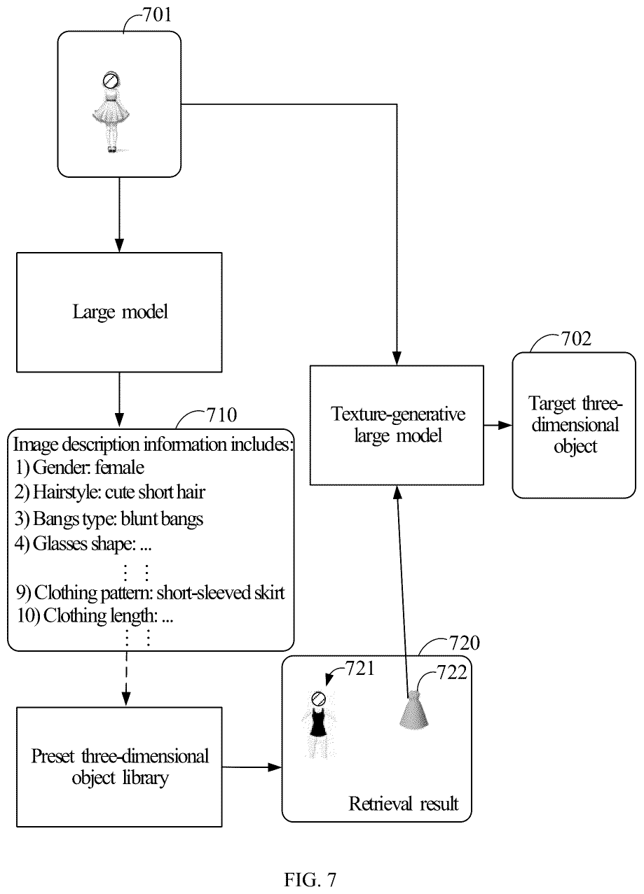

FIG. 7 schematically shows an application scenario diagram of a method of generating a virtual avatar based on a large model according to an embodiment of the present disclosure.

As shown in FIG. 7, in the application scenario, a user may input a two-dimensional target image 110 and a text command “please describe a hairstyle, bangs, a face shape, and a clothing style of a two-dimensional character in the picture”. A target image 701 may represent a virtual character wearing a purple skirt. By using the text command as a prompt word for the large model, the target image 701 and the text command may be processed by using the large model, so as to obtain object description information 710. The object description information 710 may include character description information for the virtual character and clothing description information for a clothing object. The character description information may include, for example: 1) Gender: female; 2) Hairstyle: cute short hair; 3) Bangs type: blunt bangs; 4) Glasses shape: . . . etc. The clothing description information may include, for example: 9) Clothing pattern: short-sleeved dress; 10) Clothing length: . . . etc.

By retrieving in a preset three-dimensional object library based on the character description information and the clothing description information, it may be obtained that a retrieval result 720 may be a virtual character three-dimensional object 721 and a clothing three-dimensional object 722. The clothing three-dimensional object 722 may be a three-dimensional model without texture information.

The clothing three-dimensional object 722 and the target image 701 are input into a texture-generative large model to obtain a target three-dimensional object 702. The target three-dimensional object 702 may be a texture clothing three-dimensional object having the same or similar texture information as a clothing in the target image 701. By rendering the target three-dimensional object 702 and the character three-dimensional object 721 in a three-dimensional space, a three-dimensional virtual avatar that is matched with a virtual character wearing a purple clothing in the target image 701 may be obtained. The three-dimensional virtual avatar may be used in scenarios such as animation production, intelligent customer service, etc.

According to embodiments of the present disclosure, the method of generating a virtual avatar based on a large model further includes: determining, in response to a modification request for a presented virtual avatar, a modification prompt word matched with the modification request; processing the target image, the to-be-processed image and the modification prompt word based on the texture-generative large model, so as to obtain an updated target three-dimensional object; and generating an updated virtual avatar according to the updated target three-dimensional object.

According to embodiments of the present disclosure, the modification request may be determined based on a modification operation performed by a user on a currently presented avatar. For example, the user may input a text “please lengthen sleeves of the clothes” based on any type of interactive operation, and the modification request may be generated based on an input text.

According to embodiments of the present disclosure, the modification prompt word matched with the modification request may be used to represent a modification demand for a currently presented target three-dimensional object represented by the modification request. For example, the modification prompt word may be: “lengthen sleeves of a heroine's clothes”. The modification prompt word may be used to control the texture-generative large model to process the target image and the to-be-processed image, so as to lengthen sleeves of a current three-dimensional clothing model according to a modification intention represented by the modification prompt word, and then generate an updated three-dimensional clothing model as the target three-dimensional object. An updated virtual avatar may be obtained by fusing an updated target three-dimensional object with other target three-dimensional objects that do not need to be modified.

According to embodiments of the present disclosure, the method of generating a virtual avatar based on a large model may further include: driving, in response to a target drive instruction, the virtual avatar to perform an action related to the target drive instruction.

According to embodiments of the present disclosure, the target drive instruction may be generated based on an operation request of the user, or the target drive instruction may be generated based on other methods. For example, the target drive instruction may be determined in response to a generation of the target three-dimensional object.

According to embodiments of the present disclosure, the target drive instruction may include an action parameter representing any action such as a mouth shape action, an expression change action, a posture change action, etc. An avatar may be controlled to perform an action based on the action parameter, so as to meet an action demand represented by the target drive instruction. In this way, the method of generating a virtual avatar based on a large model provided in embodiments of the present disclosure may be used in any AIGC scenario such as game animation, video production, smart e-commerce, etc.

Based on the method of generating a virtual avatar based on a large model provided by the present disclosure, the present disclosure further provides an apparatus of generating a virtual avatar based on a large model. The apparatus will be described in detail below in combination with FIG. 8

FIG. 8 schematically shows a block diagram of an apparatus of generating a virtual avatar based on a large model according to an embodiment of the present disclosure.

As shown in FIG. 8, an apparatus 800 of generating a virtual avatar based on a large model may include: an object description information obtaining module 810, a target three-dimensional object obtaining module 820 and a virtual avatar generation module 830.

The object description information obtaining module 810 is used to process a target image including a target object by using a large model, so as to obtain object description information, where the target object has texture information.

The target three-dimensional object obtaining module 820 is used to process the target image and a to-be-processed image representing an object morphology of a three-dimensional object by using a texture-generative large model, so as to obtain a target three-dimensional object with target texture information, where the three-dimensional object is determined based on the object description information, and the target texture information is matched with the texture information.

The virtual avatar generation module 830 is used to generate the virtual avatar based on the target three-dimensional object.

According to embodiments of the present disclosure, the texture-generative large model includes a texture generation network, and the to-be-processed image includes a position mapping image, and the position pixel of the position mapping image represent the three-dimensional coordinate of the object element in the three-dimensional object.

According to embodiments of the present disclosure, the target three-dimensional object obtaining module includes: a target texture map obtaining submodule and a first obtaining submodule.

The target texture map obtaining submodule is used to perform, based on the texture generation network, a feature fusion according to an object style feature and the position mapping image, so as to obtain a target texture map matched with the texture information, where the object style feature is determined based on the target image.

The first obtaining submodule is used to update the three-dimensional object based on target texture information of the target texture map, so as to obtain the target three-dimensional object.

According to embodiments of the present disclosure, the target texture map obtaining submodule includes: an initial fusion feature obtaining unit and a target fusion feature obtaining unit.

The initial fusion feature obtaining unit is used to perform the feature fusion on the position mapping image and a shape mask image in the to-be-processed image, so as to obtain an initial fusion feature, where a mask pixel of the shape mask image is used to represent whether the object element of the three-dimensional object is used to store the texture information, and a position mapping relationship is provided between the mask pixel and the object element.

The target fusion feature obtaining unit is used to perform the feature fusion based on the initial fusion feature and the object style feature, so as to obtain a target fusion feature, where the target texture map is determined based on the target fusion feature.

According to embodiments of the present disclosure, the texture-generative large model further includes a first style feature extraction network including a downsampling layer and an upsampling layer having a U-shaped network structure, and the object style features include at least one level of downsampling style feature and at least one level of upsampling style feature obtained by processing the target image through the downsampling layer and the upsampling layer.

According to embodiments of the present disclosure, the target fusion feature obtaining unit includes: a first intermediate fusion feature obtaining subunit and a first target fusion feature obtaining subunit.

The first intermediate fusion feature obtaining subunit is used to perform a feature encoding operation on the initial fusion feature and the at least one level of downsampling style feature by using a texture encoder of the texture generation network, so as to obtain a first intermediate fusion feature.

The first target fusion feature obtaining subunit is used to perform a feature decoding operation on the first intermediate fusion feature and the at least one level of upsampling style feature by using a texture decoder of the texture generation network, so as to obtain the target fusion feature.

According to embodiments of the present disclosure, the first target fusion feature obtaining subunit is configured to: perform, based on an attention mechanism, the feature decoding operation on the first intermediate fusion feature, the at least one level of upsampling style feature and the at least one level of position feature by using the texture decoder, where the position feature is determined according to the position mapping image.

According to embodiments of the present disclosure, the texture-generative large model further includes a second style feature extraction network including M-level style feature extraction layers connected in cascade, and the object style feature includes: a multi-level style feature obtained by processing the object style feature through a multi-level style extraction layer.

According to embodiments of the present disclosure, the target fusion feature obtaining unit includes: a second intermediate fusion feature obtaining subunit and a second target fusion feature obtaining subunit.

The second intermediate fusion feature obtaining subunit is used to perform a feature encoding operation on the initial fusion feature by using a texture encoder of the texture generation network, so as to obtain a second intermediate fusion feature.

The second target fusion feature obtaining subunit is used to perform a feature decoding operation on the second intermediate fusion feature and at least one level of style feature by using a texture decoder of the texture generation network, so as to obtain the target fusion feature.

According to embodiments of the present disclosure, the second target fusion feature obtaining subunit is configured to: perform, based on an attention mechanism, a feature decoding operation on the second intermediate fusion feature, the at least one level of style feature and at least one level of position feature by using the texture decoder, so as to obtain the target fusion feature, where the position feature is determined according to the position mapping image.

According to embodiments of the present disclosure, the texture-generative large model further includes a position feature extraction network including a plurality of levels of position feature extraction layers connected in cascade.

According to embodiments of the present disclosure, a plurality of levels of position features are provided, and the plurality of levels of position features are determined by processing the target image through the plurality of levels of position feature extraction layers.

According to embodiments of the present disclosure, the target three-dimensional object obtaining module includes: a target texture image obtaining submodule and a second obtaining submodule.

The target texture image obtaining submodule is used to process the target image and an object depth map of the to-be-processed image based on the texture-generative large model, so as to obtain a target texture image, where the object depth map is used to represent an image of the three-dimensional object at a specified viewing angle.

The second obtaining submodule is used to perform a texture attribute update on the three-dimensional object based on the target texture image, so as to obtain the target three-dimensional object.

According to embodiments of the present disclosure, the second obtaining submodule includes: a pixel mapping relationship determining unit, a target object map determining unit and a target three-dimensional object obtaining unit.

The pixel mapping relationship determining unit is used to determine, based on the target texture image and the object depth map, a pixel mapping relationship between a first pixel of the target texture image and a second pixel of an initial object map, where the initial object map is determined based on the three-dimensional object.

The target object map determining unit is used to update, based on the pixel mapping relationship, the initial object map according to target texture information of the target texture image, so as to obtain a target object map.

The target three-dimensional object obtaining unit is used to perform an object rendering based on the target object map, so as to obtain the target three-dimensional object.

According to embodiments of the present disclosure, the target object map determination unit includes an updating subunit.

The updating subunit is used to update, based on the pixel mapping relationship, the initial object map by using the target texture information of the target texture image at a plurality of specified viewing angles.

According to embodiments of the present disclosure, the apparatus of generating a virtual avatar based on a large model further includes: a modification prompt word determination module, a target three-dimensional object modification module and a virtual avatar modification module.

The modification prompt word determination module is used to determine, in response to a modification request for a presented virtual avatar, a modification prompt word matched with the modification request.

The target three-dimensional object modification module is used to process the target image, the to-be-processed image and the modification prompt word based on the texture-generative large model, so as to obtain an updated target three-dimensional object.

The virtual avatar modification module is used to generate an updated virtual avatar according to the updated target three-dimensional object.

According to embodiments of the present disclosure, the target object includes at least one of: a clothing object, a body part object, a vehicle object, or a building object.

According to embodiments of the present disclosure, the apparatus of generating a virtual avatar based on a large model further includes a drive module.

The drive module is used to drive, in response to a target drive instruction, the virtual avatar to perform an action related to the target drive instruction.

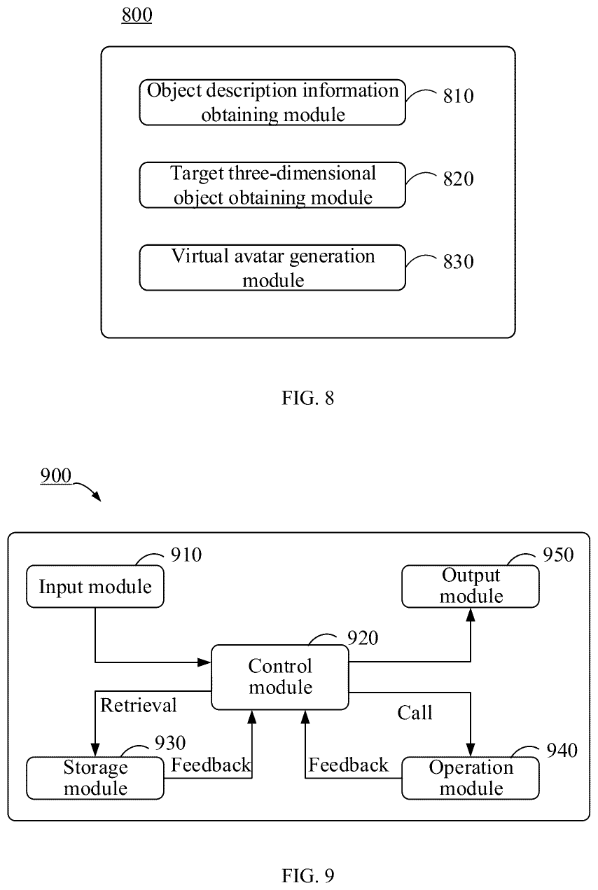

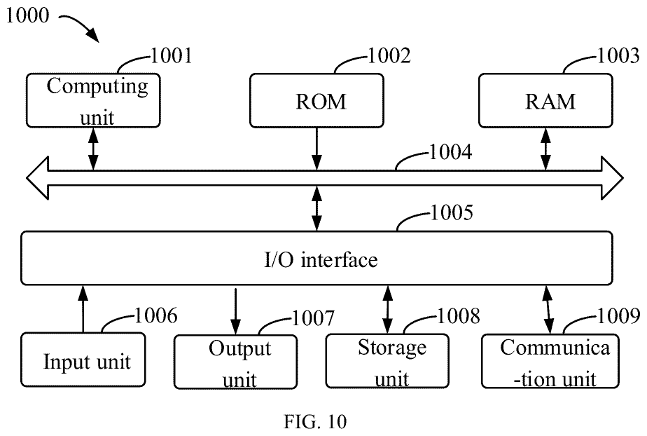

Based on the above-mentioned method of generating a virtual avatar based on a large model, embodiments of the present disclosure further provide an artificial intelligence agent used to perform the method of generating a virtual avatar based on a large model in the above embodiments. The agent will be described in detail below in combination with FIG. 9.

FIG. 9 schematically shows a structural block diagram of an artificial intelligence agent according to an embodiment of the present disclosure.

In embodiments of the present disclosure, inspired by a von Neumann structure in a modern computer theory, as shown in FIG. 9, an AI agent 900 may include five core modules: an input module 910, a control module 920, a storage module 930, an operation module 940, and an output module 950.

The input module 910 is responsible for receiving or sensing information such as a query, a request, an instruction, a signal or data, etc. from the outside world (such as a user or an external environment), and converting them into a format that may be understood and processed by the AI agent 900. The input module 910 is a primary link for the AI agent 900 to interact with the outside world, which enables the AI agent 900 to efficiently and accurately obtain the necessary “sensory” information from the outside world and respond to the information.

In the example, the input module 910 may input information such as the target image, the to-be-processed image, or the three-dimensional object, etc. as described above.

In the example, the control module 920 is a core support for an ability of the AI agent 900 to handle a complex task. The control module 920 may perform the method of generating a virtual avatar based on a large model as described above.

In the example, the control module 920 will continuously interact with the storage module 930, the operation module 940 and/or the output module 950 during operation. However, it should be noted that, in embodiments of the present disclosure, as a single initiator, the control module 920 may initiate communication with the storage module 930, the operation module 940 and/or the output module 950, and no communication coupling is provided between the storage module 930, the operation module 940 and the output module 950.

In the example, a performance of the control module 920 may be closely related to the large model on which the AI agent 900 is based. In order to give full play to a capability of the large model, an internal structure of the control module 920 may be designed to be highly configurable and extensible, so as to cope with various types of tasks and demands in a real scenario.

The storage module 930 may be responsible for memorizing information such as a historical conversation, an event stream, etc. The prompt information and data resources mentioned above may be included in the storage module 930.

In the example, after the AI agent 900 acquires a search request, the AI agent 900 may process a target image by using the large model, or may also process the target image by using the texture-generative large model, so as to obtain a target three-dimensional object. The target image may be stored in the storage module 930. The AI agent 900 may determine information such as a three-dimensional object, a to-be-processed image, etc. from the storage module 930, and feed it back to the control module 920. Then, the control module 920 may acquire the target three-dimensional object corresponding to the target image by using feedback prompt information and data resources, and deliver the target three-dimensional object to the output module 950.

The operation module 940 may be regarded as a predefined tool library. The rendering engine and the like as mentioned above may be included in the operation module 940.

In an example, the output module 950 may output the target three-dimensional object or virtual avatar described above.

The AI agent 900 according to embodiments of the present disclosure may simply and effectively improve the level of intelligence, and improve flexibility and versatility.

According to embodiments of the present disclosure, the present disclosure further provides an electronic device, a readable storage medium and a computer program product.

According to embodiments of the present disclosure, an electronic device is provided, including: at least one processor; and a memory communicatively connected to the at least one processor; where the memory stores instructions executable by the at least one processor, and the instructions, when executed by the at least one processor, are used to cause the at least one processor to implement the method as described above.

According to embodiments of the present disclosure, a non-transitory computer-readable storage medium having computer instructions therein is provided, where computer instructions are used to cause a computer system to implement the method of generating a virtual avatar based on a large model as described above.

According to embodiments of the present disclosure, a computer program product containing a computer program is provided, where the computer program, when executed by a processor, is used to cause the processor to implement the method of generating a virtual avatar based on a large model as described above.

FIG. 10 schematically shows a block diagram of an electronic device adapted to implement the method of generating a virtual avatar based on a large model according to embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 10, the electronic device 1000 includes a computing unit 1001 which may perform various appropriate actions and processes according to a computer program stored in a read only memory (ROM) 1002 or a computer program loaded from a storage unit 1008 into a random access memory (RAM) 1003. In the RAM 1003, various programs and data necessary for an operation of the electronic device 1000 may also be stored. The computing unit 1001, the ROM 1002 and the RAM 1003 are connected to each other through a bus 1004. An input/output (I/O) interface 1005 is also connected to the bus 1004.

A plurality of components in the electronic device 1000 are connected to the I/O interface 1005, including: an input unit 1006, such as a keyboard, or a mouse; an output unit 1007, such as displays or speakers of various types; a storage unit 1008, such as a disk, or an optical disc; and a communication unit 1009, such as a network card, a modem, or a wireless communication transceiver. The communication unit 1009 allows the electronic device 1000 to exchange information/data with other devices through a computer network such as Internet and/or various telecommunication networks.

The computing unit 1001 may be various general-purpose and/or dedicated processing assemblies having processing and computing capabilities. Some examples of the computing units 1001 include, but are not limited to, a central processing unit (CPU), a graphics processing unit (GPU), various dedicated artificial intelligence (AI) computing chips, various computing units that run machine learning model algorithms, a digital signal processing processor (DSP), and any suitable processor, controller, microcontroller, etc. The computing unit 1001 executes various methods and steps described above, such as the method of generating a virtual avatar based on a large model. For example, in some embodiments, the method of generating a virtual avatar based on a large model may be implemented as a computer software program which is tangibly embodied in a machine-readable medium, such as the storage unit 1008. In some embodiments, the computer program may be partially or entirely loaded and/or installed in the electronic device 1000 via the ROM 1002 and/or the communication unit 1009. The computer program, when loaded in the RAM 1003 and executed by the computing unit 1001, may execute one or more steps in the method of generating a virtual avatar based on a large model described above. Alternatively, in other embodiments, the computing unit 1001 may be configured to perform the method of generating a virtual avatar based on a large model by any other suitable means (e.g., by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from a storage system, at least one input device and at least one output device, and may transmit the data and instructions to the storage system, the at least one input device, and the at least one output device.

Program codes for implementing the methods of the present disclosure may be written in one programming language or any combination of more programming languages. These program codes may be provided to a processor or controller of a general-purpose computer, a dedicated computer or other programmable data processing apparatus, so that the program codes, when executed by the processor or controller, cause the functions/operations specified in the flowcharts and/or block diagrams to be implemented. The program codes may be executed entirely on a machine, partially on a machine, partially on a machine and partially on a remote machine as a stand-alone software package or entirely on a remote machine or server.

In the context of the present disclosure, a machine-readable medium may be a tangible medium that may contain or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), an optical fiber, a compact disk read only memory (CD-ROM), an optical storage device, a magnetic storage device, or any suitable combination of the above.

In order to provide interaction with the user, the systems and technologies described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with the user. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and the Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A method of generating a virtual avatar based on a large model, comprising:
processing a target image comprising a target object by using a large model to obtain object description information, the target object having texture information;
processing the target image and a to-be-processed image representing an object morphology of a three-dimensional object by using a texture-generative large model, so as to obtain a target three-dimensional object with target texture information, the three-dimensional object being determined based on the object description information, and the target texture information being matched with the texture information; and
generating the virtual avatar based on the target three-dimensional object.

2. The method according to claim 1, wherein the texture-generative large model comprises a texture generation network, the to-be-processed image comprises a position mapping image, and a position pixel of the position mapping image represents a three-dimensional coordinate of an object element in the three-dimensional object; and
wherein the processing the target image and a to-be-processed image representing an object morphology of a three-dimensional object by using a texture-generative large model comprises:
performing, based on the texture generation network, a feature fusion according to an object style feature and the position mapping image, so as to obtain a target texture map matched with the texture information, wherein the object style feature is determined based on the target image; and
updating the three-dimensional object based on target texture information of the target texture map, so as to obtain the target three-dimensional object.

3. The method according to claim 2, wherein the performing, based on the texture generation network, a feature fusion according to an object style feature and the position mapping image comprises:
performing the feature fusion on the position mapping image and a shape mask image in the to-be-processed image, so as to obtain an initial fusion feature, wherein a mask pixel of the shape mask image represents whether the object element of the three-dimensional object stores the texture information, and the mask pixel has a positional mapping relationship with the object element; and
performing the feature fusion based on the initial fusion feature and the object style feature to obtain a target fusion feature, wherein the target texture map is determined based on the target fusion feature.

4. The method according to claim 3, wherein the texture-generative large model further comprises a first style feature extraction network, and the first style feature extraction network comprises a downsampling layer and an upsampling layer having a U-shaped network structure, and the object style feature comprises at least one level of downsampling style feature and at least one level of upsampling style feature obtained by processing the target image through the downsampling layer and the upsampling layer; and
wherein the performing the feature fusion based on the initial fusion feature and the object style feature to obtain a target fusion feature comprises:
performing a feature encoding operation on the initial fusion feature and the at least one level of downsampling style feature by using a texture encoder of the texture generation network, so as to obtain a first intermediate fusion feature; and
performing a feature decoding operation on the first intermediate fusion feature and the at least one level of upsampling style feature by using a texture decoder of the texture generation network, so as to obtain the target fusion feature.

5. The method according to claim 4, wherein the performing a feature decoding operation on the first intermediate fusion feature and the at least one level of upsampling style feature by using a texture decoder of the texture generation network comprises:
performing, based on an attention mechanism, the feature decoding operation on the first intermediate fusion feature, the at least one level of upsampling style feature and at least one level of position feature by using the texture decoder, wherein the position feature is determined according to the position mapping image.

6. The method according to claim 3, wherein the texture-generative large model further comprises a second style feature extraction network, and the second style feature extraction network comprises cascaded M levels of style feature extraction layers, and the object style feature comprises a plurality of levels of style features obtained by processing the object style feature through a plurality of levels of style extraction layers; and
wherein the performing the feature fusion based on the initial fusion feature and the object style feature to obtain a target fusion feature comprises:
performing a feature encoding operation on the initial fusion feature by using a texture encoder of the texture generation network, so as to obtain a second intermediate fusion feature; and
performing a feature decoding operation on the second intermediate fusion feature and at least one level of style feature by using a texture decoder of the texture generation network, so as to obtain the target fusion feature.

7. The method according to claim 6, wherein the performing a feature decoding operation on the second intermediate fusion feature and at least one level of style feature by using a texture decoder of the texture generation network comprises:
performing, based on an attention mechanism, the feature decoding operation on the second intermediate fusion feature, the at least one level of style feature and at least one level of position feature by using the texture decoder, wherein the position feature is determined according to the position mapping image.

8. The method according to claim 5, wherein the texture-generative large model further comprises a position feature extraction network, and the position feature extraction network comprises a plurality of levels of position feature extraction layers connected in cascade; and
wherein a plurality of levels of position features are provided, and the plurality of levels of position features are determined by processing the target image through the plurality of levels of position feature extraction layers.

9. The method according to claim 1, wherein the processing the target image and a to-be-processed image representing an object morphology of a three-dimensional object by using a texture-generative large model comprises:
processing the target image and an object depth map of the to-be-processed image based on the texture-generative large model, so as to obtain a target texture image, wherein the object depth map represents an image of the three-dimensional object at a specified viewing angle; and
performing a texture attribute update on the three-dimensional object based on the target texture image, so as to obtain the target three-dimensional object.

10. The method according to claim 9, wherein the performing a texture attribute update on the three-dimensional object based on the target texture image so as to obtain the target three-dimensional object comprises:
determining a pixel mapping relationship between a first pixel of the target texture image and a second pixel of an initial object map based on the target texture image and the object depth map, wherein the initial object map is determined based on the three-dimensional object;
updating, based on the pixel mapping relationship, the initial object map according to target texture information of the target texture image, so as to obtain a target object map; and
performing an object rendering based on the target object map, so as to obtain the target three-dimensional object.

11. The method according to claim 10, wherein the updating, based on the pixel mapping relationship, the initial object map according to target texture information of the target texture image comprises:
updating, based on the pixel mapping relationship, the initial object map by using the target texture information of the target texture image at a plurality of specified viewing angles.

12. The method according to claim 1, further comprising:
determining, in response to a modification request for a presented virtual avatar, a modification prompt word matched with the modification request;
processing the target image, the to-be-processed image and the modification prompt word based on the texture-generative large model, so as to obtain an updated target three-dimensional object; and
generating an updated virtual avatar according to the updated target three-dimensional object.

13. The method according to claim 1, wherein the target object comprises at least one of a clothing object, a body part object, a vehicle object, or a building object.

14. The method according to claim 1, further comprising:
driving, in response to a target drive instruction, the virtual avatar to perform an action related to the target drive instruction.

15. An artificial intelligence agent, configured to implement the method according to claim 1.

16. An electronic device, comprising:
at least one processor; and
a memory communicatively connected to the at least one processor,
wherein the memory stores instructions executable by the at least one processor, and the instructions, when executed by the at least one processor, are configured to cause the at least one processor to at least:
process a target image comprising a target object by using a large model to obtain object description information, the target object having texture information;
process the target image and a to-be-processed image representing an object morphology of a three-dimensional object by using a texture-generative large model, so as to obtain a target three-dimensional object with target texture information, the three-dimensional object being determined based on the object description information, and the target texture information being matched with the texture information; and
generate the virtual avatar based on the target three-dimensional object.

17. The electronic device according to claim 16, wherein the texture-generative large model comprises a texture generation network, the to-be-processed image comprises a position mapping image, and a position pixel of the position mapping image represents a three-dimensional coordinate of an object element in the three-dimensional object; and
wherein the instructions are further configured to cause the at least one processor to at least:
perform, based on the texture generation network, a feature fusion according to an object style feature and the position mapping image, so as to obtain a target texture map matched with the texture information, wherein the object style feature is determined based on the target image; and
update the three-dimensional object based on target texture information of the target texture map, so as to obtain the target three-dimensional object.

18. The electronic device according to claim 17, wherein the instructions are further configured to cause the at least one processor to at least:
perform the feature fusion on the position mapping image and a shape mask image in the to-be-processed image, so as to obtain an initial fusion feature, wherein a mask pixel of the shape mask image represents whether the object element of the three-dimensional object stores the texture information, and the mask pixel has a positional mapping relationship with the object element; and
perform the feature fusion based on the initial fusion feature and the object style feature to obtain a target fusion feature, wherein the target texture map is determined based on the target fusion feature.

19. The electronic device according to claim 18, wherein the texture-generative large model further comprises a first style feature extraction network, and the first style feature extraction network comprises a downsampling layer and an upsampling layer having a U-shaped network structure, and the object style feature comprises at least one level of downsampling style feature and at least one level of upsampling style feature obtained by processing the target image through the downsampling layer and the upsampling layer; and
wherein the instructions are further configured to cause the at least one processor to at least:
perform a feature encoding operation on the initial fusion feature and the at least one level of downsampling style feature by using a texture encoder of the texture generation network, so as to obtain a first intermediate fusion feature; and
perform a feature decoding operation on the first intermediate fusion feature and the at least one level of upsampling style feature by using a texture decoder of the texture generation network, so as to obtain the target fusion feature.

20. A non-transitory computer-readable storage medium having computer instructions stored therein, wherein the computer instructions are configured to cause a computer to at least:
process a target image comprising a target object by using a large model to obtain object description information, the target object having texture information;
process the target image and a to-be-processed image representing an object morphology of a three-dimensional object by using a texture-generative large model, so as to obtain a target three-dimensional object with target texture information, the three-dimensional object being determined based on the object description information, and the target texture information being matched with the texture information; and
generate the virtual avatar based on the target three-dimensional object.
